(19) United States
(12) Patent Application Publication
(10) Pub. No.: US 2017/0372232 A1
(43) Pub. Date: Dec. 28, 2017

(54) DATA QUALITY DETECTION AND COMPENSATION FOR MACHINE LEARNING

(71) Applicant: PurePredictive, Inc., Sandy, UT (US)

(72) Inventors: Jason Maughan, Sandy, UT (US); Timothy McFall, North Salt Lake, UT (US)

(73) Assignee: PurePredictive, Inc., Sandy, UT (US)

(21) Appl. No.: 15/634,572

(22) Filed: Jun. 27, 2017

Related U.S. Application Data
(60) Provisional application No. 62/355,233, filed on Jun. 27, 2016.

(51) Int. Cl. G06N 99/00; G06N 5/04; G06F 3/0482

(52) U.S. Cl. CPC G06N 99/005; G06F 3/0482; G06N 5/04

(57) ABSTRACT

Apparatuses, systems, methods, and computer program products are disclosed for data quality detection and compensation for machine learning. A quality analysis module electronically identifies one or more data quality issues in machine learning training data. A corrective action module modifies training data by performing one or more corrective actions in response to one or more data quality issues. A predictive analytics module creates a machine learning model that includes one or more learned functions based on modified training data.

### CROSS-REFERENCES TO RELATED APPLICATIONS

This application claims the benefit of U.S. Provisional Patent Application No. 62/355,233 entitled “DATA QUALITY DETECTION AND COMPENSATION” and filed on Jun. 27, 2016 for Jason Maughan et al., which is incorporated herein by reference.

### FIELD

The present disclosure, in various embodiments, relates to data quality and more particularly relates to detection of and compensation for data quality as an input for machine learning.

### BACKGROUND

As the use of machine learning and other data analytics increases, many people would like to build machine learning models to generate predictions based on data, but may make mistakes in preparing the data. In addition, even sophisticated data scientists who may make few mistakes may benefit from evaluations of the datasets they have prepared for modeling.

### SUMMARY

Apparatuses are presented for data quality detection and compensation for machine learning. In one embodiment, a quality analysis module electronically identifies one or more data quality issues in machine learning training data. In a certain embodiment, a corrective action module modifies training data by performing one or more corrective actions in response to one or more data quality issues. In a further embodiment, a predictive analytics module creates a machine learning model that includes one or more learned functions based on modified training data.

Computer program products are presented for data quality detection and compensation for machine learning. In various embodiments, a computer program product includes a computer readable storage medium storing computer usable program code executable to perform operations. In one embodiment, operations include electronically identifying one or more data quality issues in machine learning training data. In a certain embodiment, operations include modifying training data by performing one or more corrective actions in response to one or more data quality issues. In a further embodiment, operations include creating a machine learning model including one or more learned functions based on modified training data.

Methods are presented for data quality detection and compensation for machine learning. A method, in one embodiment, includes electronically identifying one or more data quality issues in machine learning training data. In a certain embodiment, a method includes modifying training data by performing one or more corrective actions in response to one or more data quality issues. In a further embodiment, a method includes creating a machine learning model including one or more learned functions based on modified training data.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for predictive analytics;

FIG. 2 is a schematic block diagram illustrating one embodiment of a predictive analytics apparatus;

FIG. 3 is a schematic block diagram illustrating a further embodiment of a predictive analytics apparatus;

FIG. 4 is a schematic flow chart diagram illustrating one embodiment of a method for data quality detection and compensation for machine learning; and

FIG. 5 is a schematic flow chart diagram illustrating a further embodiment of a method for data quality detection and compensation for machine learning.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

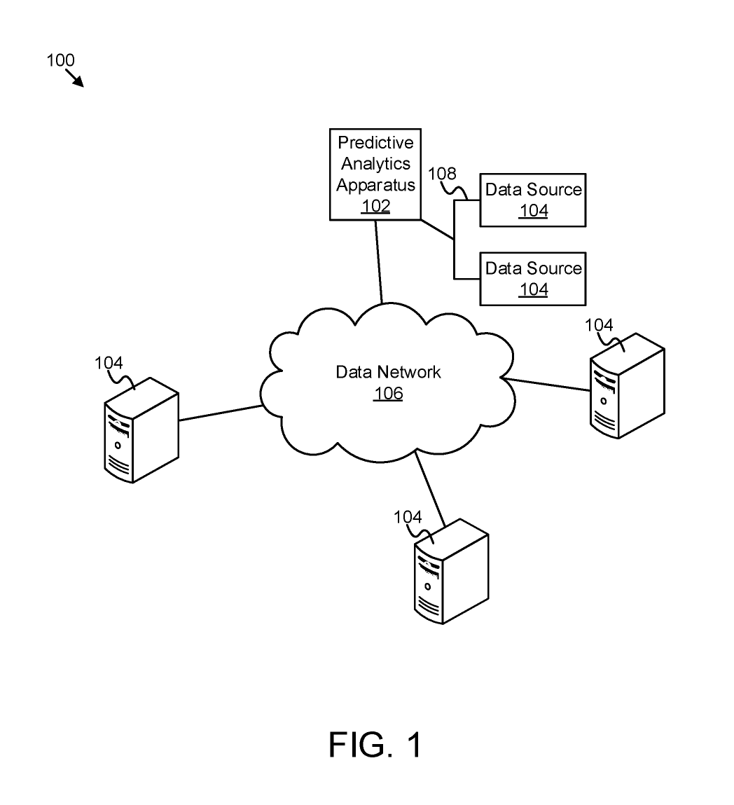

FIG. 1 is a schematic block diagram illustrating one embodiment of a system 100 for predictive analytics. The system 100, in the depicted embodiment, includes a predictive analytics apparatus 102 that is in communication with several data sources 104 and/or clients over a data network 106, and with several data sources 104 and/or clients over a local channel 108, such as a system bus, an application programming interface (API), or the like.

A data source 104 may comprise a database, one or more database tables, a spreadsheet, a comma separated value (CSV) file, one or more other flat files, a website or webpage, a user, user input, a data log, a storage device (e.g., a non-transitory computer readable storage device), a hardware computing device with a processor and a memory, and/or another data repository. A client may comprise a software application, a user, a hardware computing device with a processor and memory, or another entity in communication with the predictive analytics apparatus 102.

In general, the predictive analytics apparatus 102 generates and/or executes machine learning models for one or more clients using data from one or more data sources 104. In certain embodiments, the predictive analytics apparatus 102 may preprocess or modify the data from the data sources 104, and may generate and/or execute a machine learning model using modified data. In certain embodiments, the predictive analytics apparatus 102 provides a predictive analytics framework allowing clients to request machine learning models or other predictive analytics, to make analysis requests, and/or to receive predictive results, such as a classification, a confidence metric, an inferred function, a regression function, an answer, a prediction, a recognized pattern, a rule, a recommendation, or other results.

Predictive analytics is the study of past performance, or patterns, found in historical and transactional data to identify behavior and trends in future events. This may be accomplished using a variety of techniques including statistical modeling, machine learning, data mining, or the like.

One term for large, complex, historical data sets is Big Data. Examples of Big Data include web logs, social networks, blogs, system log files, call logs, customer data, user feedback, or the like. These data sets may often be so large and complex that they are awkward and difficult to work with using traditional tools. With technological advances in computing resources, including memory, storage, and computational power, along with frameworks and programming models for data-intensive distributed applications, the ability to collect, analyze and mine these huge repositories of structured, unstructured, and/or semi-structured data is now possible.

In certain embodiments, predictive models may be constructed to solve at least two general problem types: Regression and Classification. Regression and Classification problems may both be trained using supervised learning techniques. In supervised learning, predictive models are trained using sample historic data and associated historic outcomes. The models then make use of new data of the type used during training to predict outcomes.

Regression models may be trained using supervised learning to predict a continuous numeric outcome. These models may include Linear Regression, Support Vector Regression, K-Nearest Neighbors, Multivariate Adaptive Regression Splines, Regression Trees, Bagged Regression Trees, and Boosting, and the like.

Classification models may be trained using supervised learning to predict a categorical outcome, or class. Classification methods may include Neural Networks, Radial Basis Functions, Support Vector Machines, Naïve Bayes, k-Nearest Neighbors, Geospatial Predictive modeling, and the like.

Each of these forms of modeling makes assumptions about the data set and models the given data in a different way. Some models are more accurate than others, and which models are most accurate varies based on the data. Historically, using predictive analytics tools was a cumbersome and difficult process, often involving the engagement of a data scientist or other expert. Any easier-to-use tools or interfaces for general business users, however, typically fall short in that they still require “heavy lifting” by IT personnel in order to present and massage data and results. A data scientist typically must determine the optimal class of learning machines that would be the most applicable for a given data set, and rigorously test the selected hypothesis by first, fine-tuning the learning machine parameters, and second, evaluating results fed by trained data.

The predictive analytics apparatus 102, in certain embodiments, generates machine learning models or other predictive ensembles for the clients, with little or no input from a data scientist or other expert, by generating a large number of learned functions from multiple different classes, evaluating, combining, and/or extending the learned functions, synthesizing selected learned functions, and organizing the synthesized learned functions into a machine learning model or other predictive ensemble. The predictive analytics apparatus 102, in one embodiment, services analysis requests for the clients using the generated machine learning models, or other predictive ensembles, to produce predictions.

By generating a large number of learned functions, without regard to the effectiveness of the generated learned functions, without prior knowledge of the generated learned functions suitability, or the like, and evaluating the generated learned functions, in certain embodiments, the predictive analytics apparatus 102 may provide machine learning models that are customized and finely tuned for data from a specific client, without excessive intervention or fine-tuning. The predictive analytics apparatus 102, in a further embodiment, may generate and evaluate a large number of learned functions using parallel computing on multiple processors, such as a massively parallel processing (MPP) system or the like.

The predictive analytics apparatus 102 may service predictive analytics requests from clients locally, executing on the same host computing device as the predictive analytics apparatus 102, by providing an API to clients, receiving function calls from clients, providing a hardware command interface to clients, or otherwise providing a local channel 108 to clients. In a further embodiment, the predictive analytics apparatus 102 may service predictive analytics requests from clients over a data network 106, such as a local area network (LAN), a wide area network (WAN) such as the Internet as a cloud service, a wireless network, a wired network, or another data network 106.

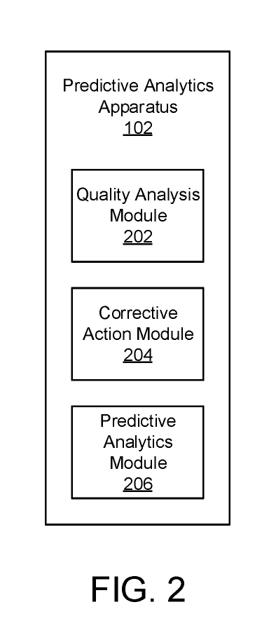

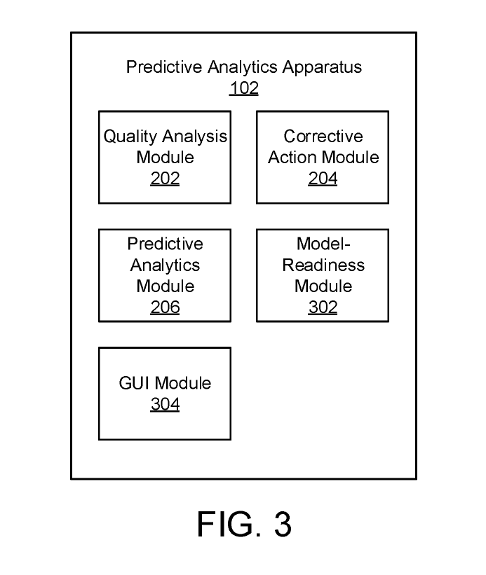

A user, however, in certain embodiments, may make errors or mistakes preparing, organizing, and/or formatting data for the predictive analytics apparatus 102. Even for an experienced data scientist, locating, correcting, and/or preventing errors or mistakes in data can be time consuming or even impossible, especially for large data sets. Accordingly, in certain embodiments, the predictive analytics apparatus 102 may electronically identify one or more data quality issues, modify data by performing one or more corrective actions in response to the one or more data quality issues, and create (or apply) a machine learning model based on the modified data. In various embodiments, electronically or automatically detecting and correcting data quality issues for machine learning data may improve a computer that implements machine learning. For example, some types of data quality issues may prevent a machine learning model from being built, or may reduce the accuracy of a machine learning model, and automatically detecting and correcting such data quality issues may allow a predictive analytics apparatus 102 to provide increased accuracy for machine learning models, without extensively involving a data scientist. A predictive analytics apparatus 102 with data quality detection and compensation is described in further detail below with regard to FIGS. 2 and 3.

FIG. 2 depicts one embodiment of a predictive analytics apparatus 102. The predictive analytics apparatus 102 of FIG. 2, in certain embodiments, may be substantially similar to the predictive analytics apparatus 102 described above with regard to FIG. 1. In the depicted embodiment, the predictive analytics apparatus 102 includes a quality analysis module 202, a corrective action module 204, and a predictive analytics module 206.

In general, in various embodiments, the quality analysis module 202 and the corrective action module 204 may reduce and/or eliminate errors, mistakes, or other data quality issues in data for the predictive analytics apparatus 102. In this manner, in certain embodiments, the quality analysis module 202 and the corrective action module 204 may reduce overfitting in machine learning models generated by the predictive analytics module 206, decrease a likelihood of including features that should not be included in modeling (e.g., dates, unique identifiers, noise, or the like), may reduce a compute time for a model (e.g., by reducing cardinality, by eliminating unnecessary features, by reducing the need to fix a dataset and remodel once a model has already been trained, or the like), may reduce problems with generalization (e.g., the model performing as well in the future as it did on the holdout dataset(s)), and/or may otherwise improve the operation of the predictive analytics module 206 and associated machine learning models on the underlying hardware computer device on which they are executing.

The quality analysis module 202, in one embodiment, is configured to electronically identify one or more data quality issues in machine learning training data. In various embodiments, machine learning training data may include any data (e.g., from data sources 104) used directly or indirectly (e.g., after modifications or corrective actions) as the basis for a machine learning model. In certain embodiments, training data (or modified training data) may be divided into subsets including a training set and a holdout set, and the predictive analytics module 206 may build learned functions for a machine learning model based on the training set, and test the accuracy of the learned functions against the holdout set. In various embodiments, training data may include historical data, statistics, big data, customer data, marketing data, computer system logs, computer application logs, data networking logs, or other data from a data source 104 or client, used by the predictive analytics module 206 to build, initialize, train, and/or test a machine learning model. In one embodiment, training data may comprise labeled data. In a further embodiment, training data may comprise unlabeled data (e.g., for semi-supervised learning or the like).

Conversely, in various embodiments, machine learning workload data may include any data (e.g., from data sources 104) used directly or indirectly (e.g., after modifications or corrective actions) in conjunction with a machine learning model to generate a prediction. A prediction may include any result from applying a machine learning model to workload data, such as a classification, a numeric result, a confidence metric, an inferred function, a regression function, an answer, a recognized pattern, a rule, a recommendation, or the like. Workload data, in various embodiments, may have substantially the same format as the training data used to train and/or evaluate a machine learning model (e.g., labeled data, unlabeled data, or the like).

For example, in one embodiment, training data and/or workload data may comprise sets of individual records or observations. As used herein, a record, instance, or observation may refer to data collected about a person, an object, an event, or the like. For example, when machine learning is used to classify objects into different categories an observation may be data about one object, data about one object at one point in time, or the like. An observation may include one or more data values. For example, an observation about an object may include data values such as length, width, and height. Similarly, an observation about a medical patient may include data values such as height, weight, and blood pressure. Various types of observations and data values suitable for use with machine learning will be clear in view of this disclosure.

Furthermore, in certain embodiments, training data and/or workload data may comprise one or more features. In various embodiments, a feature may refer to a property of one or more observations. A feature may include a column, category, data type, attribute, characteristic, label, or other grouping of data. For example, training data and/or workload data may be organized be organized in a tabular format, where rows of the table correspond to observations, and columns of the table correspond to features. As a further example, properties such as height, weight, and blood pressure may be referred to as data values when referring to an individual observation or record, but may be referred to as features when referring to a table or other collection of observations or records. Training data and/or workload data may include one or more instances of the associated features.

In certain embodiments, features in training data and/or workload data may be referred to as explanatory or independent variables and as label, target, response, or dependent variables. In general, in various embodiments, independent or explanatory variables refer to features upon which a prediction or explanation may be based, and label, target, response, or dependent variables refer to features that are to be predicted or explained. For example, in a dataset used for predicting a risk of heart disease, heart disease diagnosis (or a likelihood of heart disease) may be the dependent or target variable, and independent variables may include features such as blood pressure, cholesterol levels, age, diet information, information about tobacco use, family history information and/or the like. Various types of dependent and independent variables for machine learning datasets will be clear in view of this disclosure. In certain embodiments, a “design matrix” may refer to a set of independent variables or features, upon which a machine learning prediction is based. In various embodiments, training data and workload data may include the features of the design matrix. In certain embodiments, training data may include dependent variables, known outcomes or the like. In further embodiments, workload data may be similar to design data, but may omit dependent variables or outcomes which are to be predicted by a machine learning model. In another embodiment, however, workload data may similarly include known outcomes (e.g., for testing whether the predicted values for a dependent variable match the known outcomes).

In certain embodiments, however, data quality issues may affect various features such as independent or dependent variables. Thus, in various embodiments, the quality analysis module 202, may electronically identify one or more data quality issues in machine learning training data. A data quality issue may refer to any problem, or potential problem, that could affect the performance of the predictive analytics module 206 in creating or executing a machine learning model. Certain types of data quality issues may cause the predictive analytics module 206 to fail to build a machine learning model, to build an inaccurate machine learning model (e.g., due to overfitting, or the like). For example, a feature that includes only unique values (e.g., a different value for every observation), or that includes only one unique value (e.g., the same value for every observation, is not useful for predicting values of other features. Attempting to incorporate such a feature in the design matrix for a machine learning model may result in a failed or inaccurate model. In certain embodiments, data quality issues may increase compute time, or memory use for building or executing a machine learning model. In various embodiments, data quality issues may cause problems with generalization. For example, a machine learning model trained on data with data quality issues may perform better on a holdout set from the training data than on workload data, and may even need to be retrained with a fixed dataset.

In various embodiments, a data quality issue may include a unique id feature, a date feature, a categorical feature for which a cardinality violates a threshold, a feature with missing values, a feature with out-of-range values, or the like. Many specific types of data quality issues are described below with reference to corresponding corrective actions performed by the corrective action module 204. Many further types of data quality issues will be clear in view of this disclosure.

In certain embodiments, the quality analysis module 202 may identify problems, potential problems, or data quality issues in training data electronically or automatically. For example, in certain embodiments, the quality analysis module 202 and the corrective action module 204 may automatically pre-process training and/or workload data from data sources 104 prior to the predictive analytics module 206 creating and/or applying a machine learning model. In further embodiments, the quality analysis module 202 may determine or calculate attributes of various features, such as a number or percentage of unique values for a feature, a number or percentage of missing values or outliers for a feature, a mean, variance, or standard deviation of numerical values for a feature, or the like. In certain embodiments, the quality analysis module 202 may compare determined or calculated attributes to one or more predetermined thresholds to determine whether (or to what extent) a data quality issue exists. In one embodiment, thresholds for determining whether (or to what extent) a data quality issue exists may be set by a manufacturer of the predictive analytics apparatus 102. In another embodiment, thresholds for determining whether (or to what extent) a data quality issue exists may be set or updated by a user, such as a data scientist.

The corrective action module 204, in one embodiment, is configured to modify the training data by performing one or more corrective actions in response to the one or more data quality issues identified by the quality analysis module 202. In one embodiment, a corrective action may refer to any “fix,” correction, or other modification of a machine learning dataset (e.g., training data and/or workload data) in response to a data quality issue. In certain embodiments, a corrective action module 204 may modify training data in-place by performing corrective actions that change features, observations, or data values in the existing training data, or may create a separate dataset of modified training data. In further embodiments, the corrective action module 204 may log or track a correspondence between unmodified and modified data, so that the modified data is used internally by the predictive analytics apparatus, but so that results (e.g., predictions) are returned to a user or client with unmodified data. For example, in one embodiment, the corrective action module 204 may perform a corrective action that omits a feature from training data and workload data, but a prediction or other machine learning result may be returned to a user with the internally-omitted feature.

In various embodiments, the corrective action module 204 may perform corrective actions in response to data quality issues identified by the quality analysis module 202. A corrective action may be based on, or in response to, a data quality issue if the corrective action corrects, improves, or otherwise affects the data quality issue. In certain embodiments, the corrective action module 204 may perform one or more corrective actions for each identified problem, potential problem, or other data quality issue. In another embodiment, the corrective action module 204 may perform corrective actions for some data quality issues, but not for others, based on whether issues satisfy a threshold for correction, based on user input regarding how to respond to issues, or the like.

In various embodiments, the corrective action module 204 may perform a corrective action on the training data by: excluding a feature from the training data, excluding an observation from the training data, excluding one or more values from the training data, replacing one or more values in the training data, adding one or more engineered features to the training data, and/or the like. An engineered feature, in certain embodiments, may refer to a feature that is added to the modified data, based on one or more features of the unmodified data. For example, an “elapsed time” feature may be an engineered feature added to modified data based on two date or time features in the unmodified data. Further types of engineered features may include weekday or month features based on date features, dummy variables based on categorical features, transformed numeric features, or the like. Similarly, replacing one or more values may include imputing values, encoding values, transforming values, mapping values to bins to reduce cardinality of a feature, or the like. Various types of corrective actions are described below in relation to particular data quality issues. Further types of corrective actions will be clear in view of this disclosure.

In certain embodiment, the corrective action module 204 may modify training data by performing corrective actions in response to data quality issues in the training data, and may replicate the one or more corrective actions to modify workload data using the same corrective actions that were used to modify the training data. In one embodiment, the corrective action module 204 determines and/or executes one or more corrective actions for the training data at build time, before the data is provided to the predictive analytics module 206 for generating a machine learning or other predictive analytics model. In a further embodiment, the corrective action module 204 tracks and stores which corrective actions are taken on data at build time and replicates the same corrective actions on subsequent data at predict time. For example, in one embodiment, the quality analysis module 202 may determine that a feature that is unique for every observation has no predictive value, and the corrective action module 204 may perform a corrective action by removing that feature from the training data, and may replicate the corrective action by removing the same feature from the workload data. In further embodiments, the predictive analytics module 206 may create a machine learning model based on the modified training data, and may apply the machine learning model to the modified workload data to generate a prediction.

In one embodiment, the corrective action module 204 may apply one or more different corrective actions (e.g., different from the corrective actions applied to training data) to workload data, in response to user input. The corrective action module 204 may provide an interface allowing a user to change or update which corrective actions are taken over time, and may cooperate with the predictive analytics module 206 102 to update a model for the data, in certain embodiments, in response to a user changing or updating which corrective actions are taken of the data (e.g., in response to determining that a change or update requires a change in an associated model, or the like).

In one embodiment, the corrective action module 204 automatically performs the one or more corrective actions (e.g., without user input). The corrective action module 204, in one embodiment, is configured to perform one or more corrective actions for each identified problem (e.g., with a default corrective action or “smart” action associated with each error, problem, potential problem, or the like). The corrective action module 204, in one embodiment, performs a corrective action automatically, with little or no user interaction, in response to the quality analysis module 202 identifying and/or detecting a data quality issue such as an error or other problem or potential problem in data.

The corrective action module 204 may be configured to perform certain corrective actions automatically and others in response to user input, to perform all corrective actions automatically, or the like. In embodiments where the corrective action module 204 performs an automated corrective action, the corrective action module 204 may notify a user (e.g., in a GUI; in an email, text message, push notification, or other message; in a log; or the like) that the automated corrective action was taken. The corrective action module 204 may provide an interface allowing a user to reverse an automated corrective action after it is taken (e.g., providing a reverse button or other user interface element with the notification and explanation of the automated corrective action, or the like). In certain embodiments, each corrective action taken by the corrective action module 204 is reversible (e.g., the corrective action module 204 may store a copy of the original data, may store a reverse or undo log, or the like), allowing a user to undo or reverse actions taken by the corrective action module 204, returning data to a previous state, an original state, or the like.

In one embodiment, the corrective action module 204 determines the one or more corrective actions based on a quality level selected by a user. In various embodiments, a quality level may refer to an option selected by a user that indicates a preference regarding corrective actions. In certain embodiment, a quality level may indicate a user preference without specifying particular corrective actions, and the corrective action module 204 may select the corrective actions to perform based on the quality level. For example, the corrective action module 204, in one embodiment, may provide a user with a plurality of tiered quality level options (e.g., conservative, moderate, and aggressive; low, medium, and high; minimum and maximum; or the like) from which the user may select one, and the corrective action module 204 may determine which corrective actions to apply based on the selected quality level (e.g., based on one or more predefined rules, based on an analysis of the associated data set, based on previously received feedback from the user and/or from the predictive analytics module 206, or the like).

In one embodiment, the corrective action module 204 selects the one or more corrective actions to perform based on a model algorithm type used by the predictive analytics module 206 to create the machine learning model. A corrective action, in certain embodiments, may include fixing features in one or more specific ways only for modeling algorithms that would benefit from such a fix, fixing features in different ways based on an algorithm being used for modeling, or the like (e.g., based on feedback from the predictive analytics module 206, in response to a user defining or selecting a modeling algorithm, or the like). In certain embodiments, the corrective action module 204 may apply different corrective actions for different model or algorithm types used by the predictive analytics module 206, to create multiple versions of modified training data for the different algorithm types. In various embodiments, tailoring corrective actions 204 to particular machine learning algorithms may increase the accuracy or efficiency of machine learning models generated by the predictive analytics module 206.

The predictive analytics module 206, in various embodiments, is configured to create a machine learning model comprising one or more learned functions based on the modified training data from the corrective action module 204. A learned function, as used herein, comprises a computer readable code executable to accepts an input and provides a result. Similarly, a machine learning model may comprise computer readable code including one or more learned functions, and may be executable to accept an input (e.g., workload data) and prove a result (e.g. a prediction).

A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a prediction, a recognized pattern, a rule, a recommendation, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The predictive analytics module 206 may generate learned functions from multiple different predictive analytics classes, models, or algorithms. For example, the predictive analytics module 206 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naive Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the predictive analytics module 206 generates learned functions pseudo-randomly, without regard to the effectiveness of the generated learned functions, without prior knowledge regarding the suitability of the generated learned functions for the associated training data, or the like. For example, the predictive analytics module 206 may generate a total number of learned functions that is large enough that at least a subset of the generated learned functions are statistically likely to be effective. As used herein, pseudo-randomly indicates that the predictive analytics module 206 is configured to generate learned functions in an automated manner, without input or selection of learned functions, predictive analytics classes or models for the learned functions, or the like by a data scientist, expert, or other user.

The predictive analytics module 206, in one embodiment, is configured to create a machine learning model using learned functions. The predictive analytics module 206, in certain embodiments, may combine and/or extend learned functions to form new learned functions, may generate additional learned functions or the like for inclusion in a machine learning model. In one embodiment, the predictive analytics module 206 evaluates learned functions using a holdout subset of the modified training data, to generate evaluation metadata. The predictive analytics module 206, in a further embodiment, may evaluate combined learned functions, extended learned functions, combined-extended learned functions, additional learned functions, or the like using the holdout subset to generate evaluation metadata.

The predictive analytics module 206, in certain embodiments, maintains evaluation metadata in a metadata library. The predictive analytics module 206 may select learned functions, combined learned functions, extended learned functions, learned functions from different predictive analytics classes, and/or combined-extended learned functions) for inclusion in a machine learning model based on the evaluation metadata. In a further embodiment, the predictive analytics module 206 may synthesize the selected learned functions into a final, synthesized function or function set for a machine learning model based on evaluation metadata. The predictive analytics module 206, in another embodiment, may include synthesized evaluation metadata in a machine learning model for directing data through the machine learning model or the like.

Creating a machine learning model by generating, combining, extending, and synthesizing pseudo-randomly generated learned functions is described herein for illustrative and non-limiting purposes. In another embodiment, the predictive analytics module 206 may create a machine learning model based on the modified training data in another way. Various ways of creating and applying machine learning models based on modified training data will be clear in view of this disclosure.

In one embodiment, the predictive analytics module 206 may create a machine learning model using a model algorithm type based on the one or more data quality issues identified by the quality analysis module 202. In certain embodiments, different types of machine learning model algorithms may respond differently to different types of data quality issues, and the predictive analytics module 206 may select one or more algorithms for building a machine learning model that are compatible with the data quality issues, that reduce the need for the corrective action module 204 to apply corrective actions, or the like. The predictive analytics module 206 may exclude one or more model algorithm types based on the data quality issues or the processed data. For example, the predictive analytics module 206 may exclude deep learning algorithms for data with many rare dummy variables, rare categorical values, or the like.

In a certain embodiment, where the corrective action module 204 replicates corrective actions performed on the training data to modify the workload data, the predictive analytics module 206 applies the machine learning model to the modified workload data to generate a prediction. The predictive analytics module 206 may apply the machine learning model by executing the code of the machine learning model to process the modified workload data.

In certain embodiments, the predictive analytics module 206 may update or retrain a machine learning model. In one embodiment, updating a machine learning model may include changing parameters of an existing machine learning model. In another embodiment, updating a machine learning model may include replacing the machine learning model with a new machine learning model, based on updated data. In one embodiment, a user may update corrective actions applied to workload data by the corrective action module 204, and the predictive analytics module 206 may update or retrain a machine learning model in response. For example, the user may select different corrective actions to apply to the workload data than the corrective actions applied to the training data, and the predictive analytics module 206 may update or retrain a machine learning model based on the updated or different corrective actions.

In various embodiments, certain corrective actions performed by the corrective action module 204 may correspond to data quality issues identified by the quality analysis module 202. The following examples of data quality issues and corresponding corrective actions are provided for illustrative purposes; various further data quality issues and corresponding corrective actions will be clear in view of this disclosure.

The quality analysis module 202, in one embodiment, may detect one or more unique identifiers in data, and the corrective action module 204 may recommend and/or take one or more associated corrective actions. For example, a unique id feature comprising only unique identifiers may be part of a dataset, but often should not be included in modeling. In one embodiment, the corrective action module 204 may present likely IDs together with one or more reasons why they might be IDs, and may ask a user to flag them as IDs to confirm the quality analysis module 202's determination, or the like. The corrective action module 204 may automatically exclude features identified as IDs from the design matrix, but may also store the name of the column so that those column values can be returned with predictions, both from the training holdout(s) and from the model in production, or the like. The quality analysis module 202 may determine that a feature is an identifier in response to the feature comprising an index (e.g. a first column, one of the first columns, or the like); a feature ending with “id,” “ID,” _id,” “_ID,” “[a-z]ID,” “[a-z]id,” or the like; a feature having no missing values (e.g., no missing values within a consecutive range of possible values); a feature where all values are unique and the feature is a non-negative integer, a categorical column, or the like; and/or one or more other indicators that a feature may be an identifier. Certain indicators may be stronger than others. For example, a feature ending in “_id” or “[a-z]ID” may be a stronger indicator that a feature is an identifier than a feature ending in “id” or “ID”; a feature comprising an index as a first column may be a stronger indicator that a feature is an identifier than a feature comprising an index in another one of the first columns; or the like.

The quality analysis module 202, in certain embodiments, may identify that a feature comprises a date, and the corrective action module 204 may take one or more associated corrective actions. In one embodiment, a feature in data, such as a date feature, which does not repeat in the future will not “generalize” and therefore should not be used in predictive modeling. Since a given date will never occur again, in certain embodiments, the corrective action module 204 performs a corrective action and/or recommends a corrective action excluding dates from a design matrix for building a model.

However, in one embodiment, certain aspects of dates that do repeat may be useful to the model. Therefore, in certain embodiments, the quality analysis module 202 may automatically recognize a wide variety of dates and the corrective action module 204 may perform a corrective action to engineer features from those dates, dropping the raw dates from the design matrix for a model, or the like. For example, the corrective action module 204 may engineer and/or replace a raw date with one or more of a day of the week, an hour of the day, a day of the month, a day of the year, a quarter of the year, or the like, and may drop the associated raw date. In one embodiment, if there are multiple dates, the corrective action module 204 may determine a distance between dates (e.g., if there are multiple dates in the dataset or the like) and may drop the raw dates.

The quality analysis module 202, in one embodiment, may detect one or more categorical cardinality errors or problems, and the corrective action module 204 may perform and/or recommend one or more corrective actions. High-cardinality features may cause certain types of models to fail to perform (e.g., to not build or to not be as accurate). In addition, if certain categorical values are extremely rare, they may not add value to a feature vector. Therefore, the quality analysis module 202, in one embodiment, may provide a user with a “score” and highlight categorical features that have high cardinality, highlight features with only one unique value which may be useless in predictive modeling, or the like. In one embodiment, the quality analysis module 202 may compare cardinality of a feature to a threshold, and determine that a data quality issue exists if the cardinality violates a threshold (e.g., if the cardinality is too high, or too low). The corrective action module 204 may automatically fix those feature vectors, may recommend one or more corrective actions, or the like.

For example, the corrective action module 204 may adjust a score and/or perform or recommend a corrective action in response to detecting a feature with one or more of high cardinality, uncommon values below a certain frequency, uncommon values below a certain percentage of the feature vector, only one unique value, or the like. The corrective action module 204 may take or recommend a corrective action excluding a detected feature, reducing the cardinality of a detected feature (e.g., including only N unique values by creating an “other” category and/or imputing, keeping only the most common values or those that are the most predictive, or the like), keeping only values that occur with a given frequency, keeping only values that occur a given percentage of the time, encoding the categorical as a numeric value (e.g., randomly, alphabetically, based on the distribution of the label in other observations with and without that feature value with added random noise, or the like), binning common features together (e.g., features with similar feature values; features with similar feature content such as “Nurse,” “nurse,” and “Registered Nurse”; features with similar meaning such as “lawyer” and “attorney”; feature values that are within observations that are otherwise similar such as those that fit within the same cluster or the like), and/or performing another corrective action based on one or more detected categorical problems such as cardinality.

The quality analysis module 202, in one embodiment, may process data to detect one or more of positive and/or negative infinity. Positive and negative infinite values, in certain embodiments, may cause problems in modeling. The quality analysis module 202 may provide a score by feature and/or by dataset comprising or based on a percentage and/or number of infinite values. The corrective action module 204, in various embodiments, may perform and/or recommend performance of replacing infinite values with high or low non-infinite values, treating an infinite value as missing, excluding a feature vector with one or more infinite values.

The quality analysis module 202, in one embodiment, may process data to detect features with a high proportion of missing values. The quality analysis module 202 may provide a feature vector with a score based on missing values (e.g. 15% missing, another percent missing, or the like). A high percentage of missing values, in certain embodiments, may represent a problem with a data extraction process and/or changes in data encoding over time, so the quality analysis module 202 may notify a user so that such problems and/or changes may be corrected. The corrective action module 204, in various embodiments, may perform and/or recommend a corrective action comprising excluding a feature vector in response to a number of missing values for the feature vector satisfying a threshold, imputing one or more missing values, or the like.

The quality analysis module 202, in one embodiment, may process data to detect zero variance, near zero variance, or the like and perform and/or recommend one or more associated corrective actions. The quality analysis module 202, in certain embodiments, may determine and provide a variance score, flagging features with little or no variance, or the like, for a corrective action. For example, the corrective action module 204 may perform and/or recommend a corrective action comprising excluding a feature with variance that fails to satisfy a threshold (e.g., with variance below a threshold, or the like).

In one embodiment, the quality analysis module 202 processes data to detect a balance/distribution of label/target/dependent variables, missing values in label/target/dependent variables, or the like. The quality analysis module 202, in certain embodiments, may detect an unbalanced label, and the corrective action module 204 may provide one or more associated recommendations and/or warnings, take an associated corrective action, or the like. Providing a user with a recommendation and/or warning, in one embodiment, may allow the user to reconsider the problem they are trying to solve, re-evaluate the chosen label, or the like. In regression problems, an unusual distribution may present problems and the quality analysis module 202 may notify a user accordingly. In addition, missing values in a label/target/dependent variable, in one embodiment, may not be used in supervised learning. The quality analysis module 202 may alert a user of the problem (e.g., and/or how many of the values are missing), and the corrective action module 204 may allow the user to exclude those observations for training, to use semi-supervised learning, or the like. The user may also realize that there is a problem with the data extract and fix that and re-upload, or the like. The corrective action module 204, in various embodiments, may perform a corrective action comprising weighting the classes, sampling to increase the balance, transforming a numeric distribution or recommend excluding unusual values, or the like.

The quality analysis module 202, in one embodiment, may process data to detect an unusual distribution in numeric features. The quality analysis module 202 may score numeric features based on how “normal” their distribution is, how well the feature fits a common distribution, or the like. The corrective action module 204, in various embodiments, may perform and/or recommend one or more transformations of data (e.g. Box-Cox, or the like) in response to detecting an unusual distribution in numeric features.

In one embodiment, the quality analysis module 202 may process data to detect one or more outliers in numeric features. For example, the quality analysis module 202 may score numeric features based on out-of-range outliers or unusual values and may flag the features for a recommended and/or performed corrective action. The corrective action module 204, in various embodiments, may recommend and/or perform a corrective action comprising excluding a feature, treating outliers as missing values, replacing outliers with imputed values, excluding an observation, or the like.

The quality analysis module 202, in certain embodiments, may process data to detect and flag “ringers” or other feature vectors that were accidentally included by a user and appear to “give away” or otherwise indicate the answer (e.g., features that won't normally be available at predict time). For example, a ringer may comprise one or more features and/or feature values that are not actually known at predict time, but may accidentally have been included in training data that is extracted after an outcome is known. For example, a design matrix assembled to predict loan defaults at application time may accidentally include a count of missed payments or a sum of payments to date on each loan, or the like. The quality analysis module 202 may flag one or more features identified as ringers for user evaluation (e.g., confirmation that those features belong in the dataset), for an automatic corrective action, or the like. The corrective action module 204, in various embodiments, may take and/or recommend a corrective action for an identified ringer, such as excluding a feature, removing (e.g., treat as missing, imputing, or the like) one or more values within a feature, or the like.

In one embodiment, the quality analysis module 202 may process data to detect multicollinearity and/or duplicate feature vectors, and the corrective action module 204 may take and/or recommend an associated corrective action, such as excluding an identified feature. For example, sometimes two or more feature vectors may be created that are identical or almost identical. The quality analysis module 202 may flag such features and give them a similarity score. The corrective action module 204 may take and/or recommend a corrective action such as excluding one or more multicollinear and/or duplicate feature vectors.

The quality analysis module 202, in certain embodiments, may process data to detect one or more unusual and/or unexpected values (e.g., data types) within a feature vector, and the corrective action module 204 may perform and/or recommend an associated corrective action. For example, sometimes data encoding may change over time. Further, one or more observations may have “shifted” due to the inclusion of an extra delimiter, or the like. This may cause an unusual value to appear in a feature vector (e.g., a categorical string in a feature vector that is almost exclusively numeric, or the like). The quality analysis module 202 may identify and score features for unexpected value types, and perform and/or recommend one or more corrective actions, such as excluding a feature, treating the unexpected values as missing, replacing the unexpected values with imputed values, or the like.

In one embodiment, the quality analysis module 202 may process data to detect one or more encoded values (e.g., missing value encoding or the like). For example, missing values may be encoded as −1 (e.g. when no negative values occur in the data), several positive or negative 9's (e.g., −999999 or 999999), and/or another predefined value. The quality analysis module 202 may look for one or more missing value identifiers and may ask a user if the identified values actually represent missing values. This may be useful because certain model types may benefit from treating missing values in different ways, rather than as an arbitrary number. The corrective action module 204 may perform and/or recommend a corrective action, which may be based on a model type or the like. For some models, the encoded values may not need to be changed.

The quality analysis module 202, in certain embodiments, may process data to detect one or more patterns of missingness. For example, missing values do not always occur randomly and the quality analysis module 202 may score feature vectors with missing values to see if there is a pattern of missingness or if the missingness appears to be completely at random. If the quality analysis module 202 determines that a pattern of missingness is not completely at random, in various embodiments, the corrective action module 204 may exclude a feature, impute values for a feature, or the like, as a corrective action.

In one embodiment, the quality analysis module 202 may process data to determine whether one or more features may benefit from binning (e.g., grouping values into categorical values by range or other characteristics). For example, certain feature vectors, such as numeric features, may benefit from binning when used with certain model algorithms. The corrective action module 204 may automatically bin those features and/or recommend binning those features, when detected, based on the model used, or the like.

The quality analysis module 202, in certain embodiments, may process data to detect drift. For example, certain values may be captured and/or extracted from data differently over time, which may be referred to as “drift.” The quality analysis module 202 may score an entire dataset and/or each feature for drift. The quality analysis module 202 may identify and/or quantify drift in a variety of ways. For example, the quality analysis module 202 may take a dataset, a single feature vector, a sample of a dataset (e.g. first 10% captured and last 10% captured or the like), add a binary label based on when the data was captured, and build and score a binary classification model, or the like. If the binary classification model is able to differentiate between “older” and “newer” observations, this is likely caused by drift. Drift may occur in the design matrix or in the label/target. In response to detecting drift, the corrective action module 204 may perform and/or recommend a corrective action such as excluding the features with drift above a threshold, repairing the features with drift by imputing and/or transforming values, or the like.

The quality analysis module 202 may monitor one or more inputs (e.g., client data, initialization data, training data, test data, workload data, labeled data, unlabeled data, or the like) and/or outputs (e.g., predictions or other results) of the predictive analytics module 206, to detect one or more changes (e.g., drifting) in the one or more inputs and/or outputs. For example, in certain embodiments, the quality analysis module 202 may use machine learning and/or a statistical analysis of the one or more monitored inputs and/or outputs to detect and/or predict drift.

For example, one or more characteristics of a client's data may drift or change over time. In various embodiments, a client may adjust the way it collects data (e.g., adding fields, removing fields, encoding the data differently, or the like), demographics may change over time, a client's locations and/or products may change, a technical problem may occur in calling a predictive model, or the like. Such changes in data may cause a predictive model (e.g., an ensemble or other machine learning) from the predictive analytics module 206 to become less accurate over time, even if the predictive model was initially accurate.

Drift and/or another change in an input or output of the predictive analytics module 206 (e.g., of a predictive ensemble, one or more learned functions, or other machine learning), in certain embodiments, may comprise one or more values not previously detected for the input or output, not previously detected with a current frequency, or the like. For example, in various embodiments, the quality analysis module 202 may determine whether a value for a monitored input and/or output is outside of a predefined range (e.g., a range defined based on training data for the input and/or output), whether a value is missing, whether a value is different than an expected value, whether a value satisfies at least a threshold difference from an expected and/or previous value, whether a ratio of values (e.g., male and female, yes and no, true and false, zip codes, area codes) varies from an expected and/or previous ratio, or the like.

The quality analysis module 202, in certain embodiments, may perform a statistical analysis of one or more inputs and/or outputs (e.g., results) to determine drift. For example, the quality analysis module 202 may compare a statistical distribution of outcomes from a machine learning model generated by the predictive analytics module 206 to a statistical distribution of initialization data (e.g., training data, testing data, or the like). The quality analysis module 202 may compare outcomes from the predictive analytics apparatus 102 (e.g., machine learning predictions based on workload data) to outcomes identified in the evaluation metadata described below, in order to determine whether drift has occurred (e.g., an anomaly in the results, a ratio change in classifications, a shift in values of the results, or the like).

In certain embodiments, the quality analysis module 202 may break up and/or group results from a machine learning model generated by the predictive analytics module 206 into classes or sets (e.g., by row, by value, by time, or the like) and may perform a statistical analysis of the classes or sets. For example, the quality analysis module 202 may determine that a size and/or ratio of one or more classes or sets has changed and/or drifted over time, or the like. In one embodiment, the quality analysis module 202 may monitor and/or analyze confidence metrics from the machine learning model to detect drift (e.g., if a distribution of confidence metrics becomes bimodal and/or exhibits a different change).

In one embodiment, the quality analysis module 202 may use a binary classification (e.g., training or other initialization data labeled with a “0” and workload data labeled with a “1” or vice versa, data before a timestamp labeled with a “0” and data after the timestamp labeled with a “1” or vice versa, or another binary classification) and if the quality analysis module 202 can tell the difference between the classes (e.g., using machine learning and/or a statistical analysis), a drift has occurred. The quality analysis module 202 may perform a binary classification periodically overtime in response to a trigger (e.g., every N predictions, once a day, once a week, once a month, and/or another period). The quality analysis module 202, in one embodiment, may determine a baseline variation in data by performing a binary classification on two different groups of training data, and may set a threshold for subsequent binary classifications based on the baseline (e.g., in response to detecting a 3% baseline variation, the quality analysis module 202 may set a threshold for detecting drift higher than 3%, such as 4%, 5%, 10%, or the like).

In a further embodiment, the quality analysis module 202 may track outcomes of one or more actions made based on results from a machine learning model to detect drift or other changes. For example, the quality analysis module 202 may track payments made as loans mature, graduation rates of students over time, revenue, sales, and/or another outcome or metric, in order to determine if unexpected drift or changes have occurred. The quality analysis module 202 may store one or more values for inputs and/or outputs, results, and/or outcomes or other metrics received from a client, in order to detect drift or other changes over time.

In response to detecting a drift or other change, the quality analysis module 202, in one embodiment, may notify a user or other client. For example, the quality analysis module 202 may set a drift flag or other indicator in a response (e.g., with or without a prediction or other result); send a user a text, email, push notification, pop-up dialogue, and/or another message (e.g., within a graphical user interface (GUI) of the predictive analytics apparatus 102 or the like); and/or may otherwise notify a user or other client of a drift or other change. In certain embodiments, the quality analysis module 202 may allow the predictive analytics apparatus 102 to provide a prediction or other result, despite a detected drift or other change (e.g., with or without a drift flag or other indicator as described above). In other embodiments, the quality analysis module 202 may provide a drift flag or other indicator without a prediction or other result, preventing the predictive analytics apparatus 102 from making a prediction or providing another result (e.g., and providing an error comprising a drift flag or other indicator instead).

The quality analysis module 202 may provide a drift flag or other indicator at a record granularity (e.g., indicating which record(s) include one or more drifted values), at a feature granularity (e.g., indicating which feature(s) include one or more drifted values), or the like. In certain embodiments, the quality analysis module 202 provides a drift flag or other indicator indicating an importance and/or priority of the drifted record and/or feature (e.g., a ranking of the drifted record and/or feature relative to other records and/or features in order of importance or impact on a prediction or other result, an estimated or otherwise determined impact of the drifted record and/or feature on a prediction or other result, or the like).

The quality analysis module 202, in one embodiment, provides a user or other client with a drift summary comprising one or more drift statistics, such as a difference in one or more values over time, a score or other indicator of a severity of the drift or change, a ranking of the drifted record and/or feature relative to other records and/or features in order of importance or impact on a prediction or other result, an estimated or otherwise determined impact of the drifted record and/or feature on a prediction or other result, or the like. The quality analysis module 202 may provide a drift summary and/or one or more drift statistics in a predefined location, such as in a footer of a result file or other data object, may include a pointer and/or address for a drift summary and/or one or more drift statistics in a result data packet or other data object, or the like.

In certain embodiments, the predictive analytics module 206, in response to the quality analysis module 202 detecting drift or change in one or more values for an input and/or output of the predictive analytics apparatus 102, may automatically correct or attempt to correct the drift, by retraining machine learning (e.g., one or more ensembles or portions thereof, one or more learned functions, or the like as described below) using the predictive analytics apparatus 102, by intelligently modifying and/or adjusting the drifted values using the corrective action module 204, or the like. For example, in one embodiment, the predictive analytics module 206 may request additional training data from a user or other client, in order to train a new ensemble or other machine learning. The predictive analytics apparatus 102 may provide an interface (e.g., a prompt, an upload element, or the like) within a GUI, as part of or in response to an alert or other message notifying the user or other client of the drift or other change and allowing the user or other client to provide additional training data.

In a further embodiment, the predictive analytics module 206 may retrain a new ensemble, portion thereof, or other machine learning using one or more outcomes received from a user or other client, as described above. The predictive analytics module 206, in certain embodiments, may periodically request outcome data and/or training data from a user or other client regardless of whether drift has occurred, so that the predictive analytics module 206 may automatically retrain machine learning in response to detecting drift, without additional input from the user or other client. In one embodiment, the predictive analytics module 206 may have access to training data and/or outcome data for a user or other client, such as one or more databases, spreadsheets, files, or other data objects, and the predictive analytics module 206 may retrain machine learning for the user or other client in response to detecting drift without further input from the user or other client, or the like.

The predictive analytics module 206, in certain embodiments, may retrain one or more ensembles or other machine learning for a user or other client without additional data from the user or other client, by using the corrective action module 204 to exclude records and/or features for which values have drifted or otherwise changed. For example, the corrective action module 204 may exclude an entire feature and/or record if one or more of its values (e.g., a predetermined threshold amount) have drifted, changed, and/or are missing; may just exclude the drifted, changed, and/or missing values; may estimate and/or impute different values for drifted, changed, and/or missing values (e.g., based on training data, based on previous workload data, or the like); may shift the drifted distribution of values into an expected range; or the like. The corrective action module 204, in one embodiment, may use the predictive analytics apparatus 102 to create an ensemble or other machine learning to predict missing values in a manner that may be more accurate than imputation and/or excluding the missing values.

In certain embodiments, the predictive analytics module 206 may use one or more retrained ensembles or other machine learning temporarily until a user or other client provides the predictive analytics apparatus 102 with additional data (e.g., training data, outcome data) which the predictive analytics module 206 may use to retrain the one or more ensembles or other machine learning again with actual data, which may be more accurate.

In one embodiment, the predictive analytics module 206 may generate machine learning (e.g., one or more ensembles, learned functions, and/or other machine learning) configured to account for expected drift, configured for complete and/or partial retraining to account for drift, or the like. For example, in certain embodiments, at training time, the quality analysis module 202 may detect one or more values that are missing from one or more records in the training data, and may include one or more thresholds for predictions based on the missing values (e.g., if 2% of records are missing a value for a feature in training data, the predictive analytics apparatus 102 may include a rule that the feature is to be used in predictions if up to 3% of records are missing value for the feature, but the feature is to be ignored if greater than 3% of records are missing values for the feature, a user is to be alerted if greater than 10% of records are missing values for the feature, or the like). Different features may have different weights or different drift thresholds, or the like, allowing for greater drift for features with less impact on predictions than for features with greater impact on predictions, or the like. In certain embodiments, the predictive analytics module 206 may be configured to modify and/or adjust the routing of data to account for drift using an existing machine learning model or other predictive program.

The quality analysis module 202 or the predictive analytics module 206 may estimate or otherwise determine an impact of the missing features and/or records on the original machine learning and/or on the retrained machine learning and may provide the impact to a user or other client. For example, the predictive analytics module 206 may make multiple predictions or other results using data in a normal and/or expected range, and the quality analysis module 202 may compare the predictions or other results to those made without the data, to determine an impact of missing the data on the predictions or other results. The predictive analytics module 206, in one embodiment, may retrain machine learning excluding one or more feature and retrain machine learning replacing drifted, changed, and/or missing values with expected values, comparing and/or evaluating predictions or other results from both and selecting the most accurate retrained machine learning for use, or the like.

The predictive analytics module 206, in one embodiment, may provide an interface (e.g., a GUI, an API, a command line interface (CLI), a web service or TCP/IP interface, or the like) allowing a user or other client to select an automated mode for the predictive analytics module 206, in which the predictive analytics module 206 will automatically self-heal drifted, changed, and/or missing values, by replacing the values with expected values, by retraining machine learning without the values or with replacement values, by retraining machine learning using alternate training data or outcome data, or the like.

In a further embodiment, the predictive analytics module 206 may prompt a user or other client with one or more options for repairing or healing detected drift, such as an option for uploading new training data and retraining machine learning, an option for using existing machine learning with replacement expected values provided by the corrective action module 204 in place of drifted values, retraining machine learning without drifted values, retraining machine learning with replacement expected values, retraining machine learning with held back training data in which the drifted values are also found, do nothing, and/or one or more other options selectable by the user or other client. In the prompt, the predictive analytics module 206, in certain embodiments, may include instructions for the user or other client on how to fix or repair the drifted, changed, and/or missing data (e.g., values should be within range M-N, values should be encoded with a specific encoding or format, values should be selected from a predefined group, values should follow a predefined definition, or the like), as determined by the predictive analytics module 206. The predictive analytics module 206 may display to a user or other client an old/original distribution of values and a new/drifted distribution of values (e.g., side by side, overlaid, or the like), one or more histograms of old/original values and/or new/drifted values, display a problem or change in the data leaving it to the user to determine a repair, or the like.

The predictive analytics module 206, in one embodiment, performs one or more tests on retrained machine learning, to determine whether predictions from the retrained machine learning are more accurate than from the original machine learning. For example, the predictive analytics module 206 may perform A/B testing, using both the original machine learning and the retrained machine learning for a predefined period after retraining the machine learning, alternating between the two, randomly selecting one or the other, and/or providing predictions or other results from both the original machine learning and the retrained machine learning to a user or other client. The predictive analytics module 206 may perform the testing for a predefined trial period, then may select the more accurate machine learning, may allow a user or other client to select one of the original machine learning and the retrained machine learning, or the like for continued use.

FIG. 3 depicts a further embodiment of a predictive analytics apparatus 102. The predictive analytics apparatus 102 of FIG. 3, in certain embodiments, may be substantially similar to the predictive analytics apparatus 102 described above with regard to FIGS. 1 and 2. In the depicted embodiment, the predictive analytics apparatus 102 includes a quality analysis module 202, a corrective action module 204, and a predictive analytics module 206, which may be substantially as described above with regard to FIG. 2. In the depicted embodiment, the predictive analytics apparatus 102 further includes a model-readiness module 302 and a graphical user interface (GUI) module 304.

The model-readiness module 302, in one embodiment, is configured to provide one or more model-readiness scores to a user based on the one or more data quality issues identified by the quality analysis module 202. For example, the model-readiness module 302 may provide an overall model-readiness score, multiple model-readiness scores by category, or the like) for an overall dataset/design matrix, for each feature within a dataset, for one or more label/target/dependent variables, or the like.

In various embodiments, a model-readiness score may be or include a score for the training data, a score for a feature of the training data, a score for a dependent variable, a score for a potential data quality issue, and/or the like. Various scores discussed above for different data quality issues may be presented to a user by the model-readiness module. In certain embodiments, a model-readiness score may be a “ready” or “not ready” classification, a numeric score indicating a potential severity of a data quality issue, a score for an individual feature, or a particular type or category of data quality issues, a sum of scores for individual features or categories, and average of scores for individual features or categories, or the like. The model-readiness module 302, in one embodiment, may present a “scorecard” or other summary of multiple scores for training data or workload data (e.g., an overall score; sub-scores for different features, different data sets, different identified problem or error types; or the like). Many types of possible model-readiness scores will be clear in view of this disclosure. In various embodiments, presenting one or more model-readiness score to a user may allow a user to provide input to the corrective action module 204 to select corrective actions based on the model-readiness score(s). For example, in certain embodiments, scaled or weighted model-readiness scores may indicate data quality issues for which corrective actions will have a greater effect or a lesser effect.

The GUI module 304, in one embodiment, is configured to interactively presents the one or more data quality issues identified by the quality analysis module 202, and one or more potential corrective actions to a user. A “potential” corrective action may be a possible or recommended corrective action, and the one or more corrective actions actually performed by the corrective action module 204 may be selected by the user from the one or more potential corrective actions.

In a certain embodiment, the GUI module 304 provides a GUI to a user, and the corrective action module 204 performs a corrective action on data in response to and/or based on user input, or the like. The GUI module 304 may perform an interactive process with the user, presenting the user a few identified or flagged features with errors or problems from a much larger plurality of features (e.g., hundreds or thousands of features, or more), stepping through each identified error or problem with the user to receive user input authorizing or denying an associated corrective action.

In a further embodiment, the GUI module 304 may allow a user to select from a list which of a plurality of corrective actions the corrective action module 204 takes on data (e.g., with check boxes or other user interface elements). When the data corrective action module 204 is configured with multiple possible corrective actions for a single error or other data problem, the GUI module 304, in one embodiment, may allow a user to select which corrective action to take, to select multiple non-mutually-exclusive corrective actions, to select no corrective action, or the like.

In one embodiment, the GUI module 304 may allow a user to authorize or deny performance of one or more recommended corrective actions (e.g., fixes or the like). In certain embodiments, the GUI module 304 may provide automatic and/or single-click recommended fixes to the data along with explanations of the errors and the fixes. For example, the GUI module 304 may provide a user with a list of one or more recommended corrective actions, and may prompt the user to accept all recommended corrective actions, to cancel or deny all recommended corrective actions, or the like.

Thus, in one embodiment, the GUI module 304 may present a subset of the one or more potential corrective actions as default, or recommended corrective actions. A default or recommended corrective action may be selected by the corrective action module 204 based on one or more factors such as a severity of a data quality issue, a quality level selected by a user, or the like. In a further embodiment, the GUI module 304 may present an interface allowing the user to accept the default corrective actions as a set. For example, in one embodiment, the GUI module 304 may present a single-click option to accept or deny the recommended or default corrective actions. In a further embodiment, the GUI may present a selection interface allowing the user to choose individual corrective actions in response to the user denying the default set of corrective actions. The corrective action module 204 may then perform corrective actions selected by the user, either by the user accepting the default corrective actions or choosing individual corrective actions.

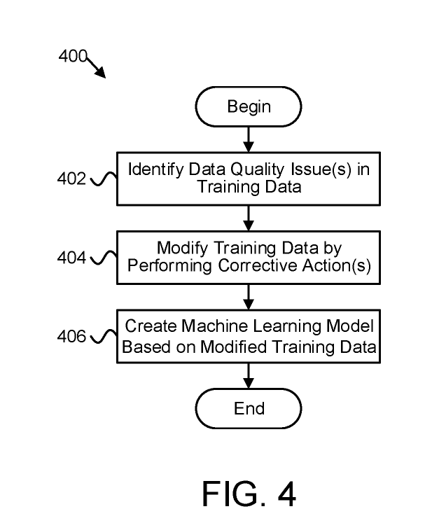

FIG. 4 is a schematic flow chart diagram illustrating one embodiment of a method 400 for data quality detection and compensation for machine learning. The method 400 begins, and a quality analysis module 202 electronically identifies 402 one or more data quality issues in machine learning training data. A corrective action module 204 modifies 404 the training data by performing one or more corrective actions in response to the one or more data quality issues. A predictive analytics module 206 creates 406 a machine learning model comprising one or more learned functions based on the modified training data, and the method 400 ends.

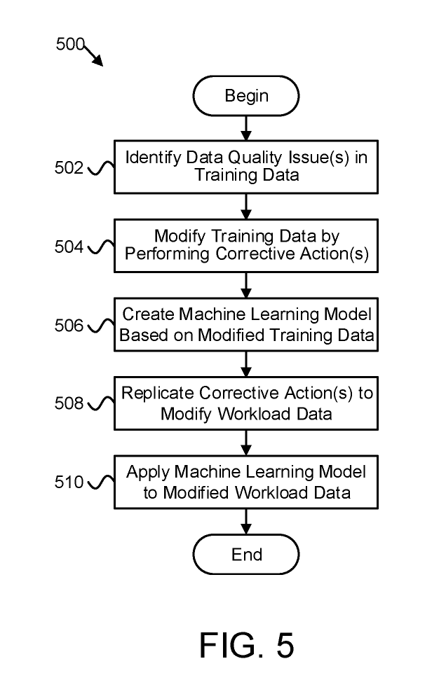

FIG. 5 is a schematic flow chart diagram illustrating another embodiment of a method 500 for data quality detection and compensation for machine learning. The method 500 begins, and a quality analysis module 202 electronically identifies 502 one or more data quality issues in machine learning training data. A corrective action module 204 modifies 504 the training data by performing one or more corrective actions in response to the one or more data quality issues. A predictive analytics module 206 creates 506 a machine learning model comprising one or more learned functions based on the modified training data. The corrective action module 204 replicates 508 the one or more corrective actions to modify workload data using the one or more corrective actions. The predictive analytics module 206 applies 510 the machine learning model to the modified workload data to generate a prediction, and the method 500 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a quality analysis module that electronically identifies one or more data quality issues in machine learning training data;
a corrective action module that modifies the training data by performing one or more corrective actions in response to the one or more data quality issues; and
a predictive analytics module that creates a machine learning model comprising one or more learned functions based on the modified training data.

2. The apparatus of claim 1, wherein the corrective action module replicates the one or more corrective actions to modify workload data using the one or more corrective actions, and the predictive analytics module applies the machine learning model to the modified workload data to generate a prediction.

3. The apparatus of claim 2, wherein the corrective action module applies one or more different corrective actions to the workload data in response to user input, and the predictive analytics module updates the machine learning model based on the one or more different corrective actions.

4. The apparatus of claim 1, further comprising a model-readiness module that provides one or more model-readiness scores to a user based on the one or more data quality issues, a model-readiness score comprising one or more of a score for the training data, a score for a feature of the training data, a score for a dependent variable, and a score for a potential data quality issue.

5. The apparatus of claim 1, wherein the corrective action module automatically performs the one or more corrective actions, notifies a user of the one or more corrective actions, and provides an interface for the user to reverse the one or more corrective actions.

6. The apparatus of claim 1, wherein the corrective action module determines the one or more corrective actions based on a quality level selected by a user.

7. The apparatus of claim 1, further comprising a graphical user interface (GUI) module that interactively presents the one or more data quality issues and one or more potential corrective actions to a user, wherein the one or more corrective actions are selected by the user from the one or more potential corrective actions.

8. The apparatus of claim 7, wherein the GUI module presents a subset of the one or more potential corrective actions as default corrective actions.

9. The apparatus of claim 8, wherein the GUI module presents an interface allowing the user to accept the default corrective actions as a set.

10. The apparatus of claim 1, wherein the predictive analytics module creates the machine learning model using a model algorithm type based on the one or more data quality issues.

11. The apparatus of claim 1, wherein the corrective action module selects the one or more corrective actions based on a model algorithm type used by the predictive analytics module to create the machine learning model.

12. The apparatus of claim 1, wherein the one or more corrective actions comprise one or more of: excluding a feature from the training data, excluding an observation from the training data, excluding one or more values from the training data, replacing one or more values in the training data, and adding one or more engineered features to the training data.

13. The apparatus of claim 1, wherein the one or more data quality issues comprise one or more of: a unique id feature, a date feature, a categorical feature for which a cardinality violates a threshold, a feature with missing values, and a feature with out-of-range values.

14. A computer program product comprising a computer readable storage medium storing computer usable program code executable to perform operations, the operations comprising:
electronically identifying one or more data quality issues in machine learning training data;
modifying the training data by performing one or more corrective actions in response to the one or more data quality issues; and
creating a machine learning model comprising one or more learned functions based on the modified training data.

15. The computer program product of claim 14, the operations further comprising providing one or more model-readiness scores to a user based on the one or more data quality issues, a model-readiness score comprising one or more of a score for the training data, a score for a feature of the training data, a score for a dependent variable, and a score for a potential data quality issue.

16. The computer program product of claim 14, wherein the one or more corrective actions are automatically performed, the operations further comprising notifying a user of the one or more corrective actions, and providing an interface for the user to reverse the one or more corrective actions.

17. The computer program product of claim 14, wherein the one or more corrective actions are based on a quality level selected by a user.

18. The computer program product of claim 14, the operations further comprising interactively presenting the one or more data quality issues and one or more potential corrective actions to a user, wherein the one or more corrective actions are selected by the user from the one or more potential corrective actions.

19. A method comprising:
electronically identifying one or more data quality issues in machine learning training data;
modifying the training data by performing one or more corrective actions in response to the one or more data quality issues; and
creating a machine learning model comprising one or more learned functions based on the modified training data.

20. The method of claim 19, further comprising:
replicating the one or more corrective actions to modify workload data using the one or more corrective actions; and
applying the machine learning model to the modified workload data to generate a prediction.
